(19) United States
(12) Patent Application Publication
(10) Pub. No.: US 2025/0238845 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Junichi SATO, Tokyo (JP); Yoshihisa IJIRI, Tokyo (JP)

(21) Appl. No.: 18/973,588

(22) Filed: Dec. 9, 2024

(30) Foreign Application Priority Data
Jan. 19, 2024 (JP) 2024-006920

(51) Int. Cl. G06Q 30/0241; G06N 20/00; G06Q 30/0242

(52) U.S. Cl. CPC G06Q 30/0276; G06N 20/00; G06Q 30/0244

(57) ABSTRACT

An information processing apparatus according to the present application includes an acquisition unit and an estimation unit. The acquisition unit acquires evaluation information that is information indicating evaluation on a service using generation information that is information that is generated by using generative AI based on a prompt that includes pieces of information on a plurality of items. The estimation unit estimates degrees of importance of the plurality of items based on the evaluation information that is acquired by the acquisition unit.

### CROSS-REFERENCE TO RELATED APPLICATIONS

The present application claims priority to and incorporates by reference the entire contents of Japanese Patent Application No. 2024-006920 filed in Japan on Jan. 19, 2024.

### BACKGROUND OF THE INVENTION

### 1. Field of the Invention

The present invention relates to an information processing apparatus, an information processing method, and an information processing program.

### 2. Description of the Related Art

In recent years, a technology for generating information by using generative Artificial Intelligence (AI) is known. For example, Japanese Patent No. 7313757 discloses a technology using Large Language Models (LLM) for generating a prompt in which a sentence that is effective to an input query sentence is added as an additional sentence within a range of predetermined character limit. The prompt is information that is input to the generative AI and is information that indicates, for example, an instruction, a request, or the like that is given to the generative AI for causing the generative AI to perform a specific task.

However, in the conventional technology as described above, the LLM to which a query sentence is input from a user is able to generate an additional sentence, but there is room for improvement to more accurately optimize the prompt.

### SUMMARY OF THE INVENTION

An information processing apparatus according to the present application includes an acquisition unit and an estimation unit. The acquisition unit acquires evaluation information that is information indicating evaluation on a service using generation information that is information that is generated by using generative AI based on a prompt that includes pieces of information on a plurality of items. The estimation unit estimates degrees of importance of the plurality of items based on the evaluation information that is acquired by the acquisition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining information processing according to one embodiment;

FIG. 2 is a diagram illustrating an example of a configuration of an information processing system according to one embodiment;

FIG. 3 is a diagram illustrating an example of a configuration of an information processing apparatus according to one embodiment;

FIG. 4 is a flowchart illustrating an example of information processing performed by a processing unit of the information processing apparatus according to one embodiment;

FIG. 5 is a flowchart illustrating an example of a process of generating a prompt or the like by the processing unit of the information processing apparatus according to one embodiment; and

FIG. 6 is a diagram illustrating an example of a hardware configuration of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. In addition, in each of the embodiments described below, the same components are denoted by the same reference symbols, and repeated explanation will be omitted.

### 1. One Example of Information Processing

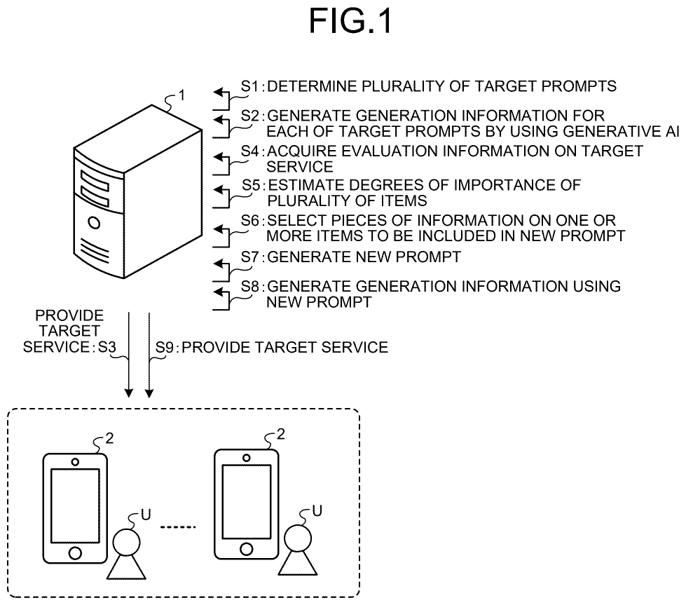

Firstly, an example of information processing according to one embodiment will be described with reference to FIG. 1. FIG. 1 is a diagram for explaining information processing according to one embodiment.

An information processing apparatus 1 illustrated in FIG. 1 is an information processing apparatus that provides various kinds of information to users U in an online manner by cooperating with each of terminal apparatuses 2 of the users U, and is implemented by for example, one or more servers, cloud systems, or the like. The terminal apparatuses 2 are, for example, smartphones, tablets, personal computers, or the like.

As illustrated in FIG. 1, the information processing apparatus 1 determines, as target prompts, a plurality of prompts each including a different combination of pieces of information on a plurality of items (Step S1). Each of the items is an item that indicates a type of a key matter or a characteristic matter, and is, for example, an item that indicates a semantic type, such as a semantic field. Further, the information on the item is information that indicates a content of the key matter, information that indicates a content of the characteristic matter, or the like.

The target prompts that are determined at Step S1 are pieces of information that are to be input to a generative Artificial Intelligence (AI) (to be described later) for generating provision information that is information to be provided to the user U in a service that is provided by the information processing apparatus 1. In the following, explanation will be given based on the assumption that the service that is provided by the information processing apparatus 1 is an advertisement distribution service, but the service that is provided by the information processing apparatus 1 is not limited to the advertisement distribution service.

When the service that is provided by the information processing apparatus 1 is the advertisement distribution service, the prompts that are determined at Step S1 are pieces of information that are to be input to the generative AI (to be described later) for generating an advertisement content. The advertisement content is, for example, a content that includes at least one of text and an image.

The plurality of target prompts that are determined at Step S1 are prompts related to the same target; however, the plurality of prompts may be prompts that are related to different targets or a part of the prompts may be related to different targets. For example, the plurality of target prompts that are determined at Step S1 are prompts for generating an advertisement content that includes link information on a specific landing page; however, the prompts may be prompts for generating different advertisement contents for a plurality of different landing pages.

A prompt to be input to the generative AI (to be described later) for generating the advertisement content is, for example, information on a character string of “Please create an advertisement content for an organic coffee shop that has cozy interior and that is to be newly opened, where the advertisement content has a design targeted for local community.”

In this case, the pieces of information on the plurality of items are information on a character string of “cozy interior”, information on a character string of “newly opened”, information on a character string of “organic coffee shop”, information on a character string of “local community”, and the like.

The information on the character string of “cozy interior” is information on an item of “interior design of store”, the character string of “newly opened” is an item of “store condition”, the information on the character string of “organic coffee shop” is information on an item of “store category”, and the information on the character string of “local community” is information on an item of “place of residence of target user”. The information on the item of “place of residence of target user” is one example of information that indicates an attribute of the target user U.

Meanwhile, the information on the item is not limited to the examples as described above, and may be, for example, information on an item of “place of store”, information on an item of “event”, information on an item of “coupon discount”, information on an item of “product price”, an item of “age group of target user”, an item of “interest of target user”, or the like.

Furthermore, the information on the item may be, for example, information on an item of “tone of speech”, information on an item of “prompt format”, or the like. The information on the item of “tone of speech” is, for example, information on a direct instruction, such as “do”, or an indirect instruction, such as “please”. The item of “prompt format” is information on, for example, Zero-shot, One-shot, or Few-shot.

Moreover, in the example as described above, the advertisement content of a real store is described as one embodiment, but the advertisement content is not limited to the advertisement content of the real store. For example, the advertisement content may be an advertisement content of a virtual store in an electronic commerce site, an advertisement content of a product that is sold in the real store or the store, or other advertisement contents.

The information processing apparatus 1, when receiving a prompt determination request that is transmitted from a business operator terminal that is a terminal apparatus of an advertiser for example, extracts pieces of information on a plurality of items from among pieces of information that are included in the prompt determination request. Further, the information processing apparatus 1 determines, as the plurality of target prompts as described above, a plurality of prompts each including a different combination of pieces of information on two or more items from among the extracted pieces of information on the plurality of items.

The information processing apparatus 1 has dictionary information that includes, for example, a plurality of terms for each of the items, and is able to extract pieces of information on a plurality of items from among the pieces of information that are included in the prompt determination request by using the dictionary information. Further, the information processing apparatus 1 is able to extract pieces of information on a plurality of items from among the pieces of information that are included in the prompt determination request by using text generative AI, such as Large Language Models.

Furthermore, the information processing apparatus 1 is able to transmit, for example, template information for allowing a user to input or select pieces of information on a plurality of items that are determined in advance to the business operator terminal that is the terminal apparatus of the advertiser, and cause the business operator terminal to display the template information. In this case, the advertiser is able to input or select the pieces of information on the plurality of items by operating the business operator terminal, and accordingly, the prompt determination request that includes the pieces of information on the plurality of items is transmitted from the business operator terminal to the information processing apparatus 1.

The prompt determination request that is transmitted from the business operator terminal may include information for identifying a landing page that is a target of an advertisement. In this case, the information processing apparatus 1 is able to extract the pieces of information on the plurality of items from the landing page that is identified by the prompt determination request, by using a dictionary, the generative AI, or the like as described above. The information processing apparatus 1 determines, as the plurality of target prompts as described above, a plurality of prompts each including a different combination of pieces of information on two or more items from among the extracted pieces of information on the plurality of items.

Meanwhile, the target prompt may be, for example, a prompt that is generated by using the generative AI. Further, the target prompt is not limited to a character prompt, but may include, for example, image data in addition to the character prompt.

In this case, in the target prompt, the character prompt is, for example, information on a character string of “Please create an advertisement content for an organic coffee shop that has cozy interior and that is to be newly opened, based on input image data”, and the image data is data that represents an image of a reference advertisement content.

The information on the item included in the target prompt is not limited to the information on the item included in the character prompt, and may include, for example, information that indicates a type of the image represented by the image data or information on an item that is included in the image represented by the image data. The information on the item that is included in the image represented by the image data may be an object, a scene, an emotion, a color, or the like that is illustrated in the image represented by the image data, but embodiments are not limited to this example.

Meanwhile, when the prompt determination request includes a plurality of prompts, the information processing apparatus 1 is able to determine the prompts that are included in the prompt determination request as a plurality of target prompts.

Subsequently, the information processing apparatus 1 performs a process of inputting, as input information, information including the target prompts that are prompts including the pieces of information on the plurality of items that are determined at Step S1 to a generative AI, and causing the generative AI to generate generation information corresponding to the input information for each of the target prompts that are determined at Step S1 (Step S2).

Examples of the generative AI include text generative AI, image generative AI, and multimodal generative AI. The text generative AI is, for example, Large Language Models that are trained to estimate and output a next token from an input token string, and is, for example, a transformer-based model or a Recurrent Neural Network (RNN)-based model, or may be a model in which the above-described models are mixed. Further, the text generative AI may be a complex system that includes an identification machine for prevention of misuse.

Examples of the transformer-based model include a Generative Pre-trained Transformer (GPT) and Pathways Language Model Version 2 (PaLM2), but embodiments are not limited to this example. Examples of the RNN-based model include a Receptance Weighted Key Value (RWKV), but embodiments are not limited to this example.

The image generative AI is AI that generates an image from text, and is, for example, Generative Adversarial Networks (StackGAN), AttnGAN, Text-to-Image (T2I) with Transformers, and a Diffusion model, but embodiments are not limited to this example. Examples of the Diffusion model include DALL-E and Stable-Diffusion.

The multimodal generative AI is, for example, generative AI that generates at least one of text, an image, and audio from at least one of text, an image, and audio. Examples of the multimodal generative AI include GPT-4 Turbo with vision, gemini, and a Chameleon Multimodal Model (CM3Leon), but embodiments are not limited to this example.

Meanwhile, it is preferable that the generative AI is trained so as not to include personal information or the like in a generation result. The generative AI is arranged in an external information processing apparatus and the information processing apparatus 1 uses the generative AI via an Application Programming Interface (API) that is provided by the external information processing apparatus; however, the generative AI may be arranged in the information processing apparatus 1.

Subsequently, the information processing apparatus 1 provides a target service, which is a service using the generation information that is information generated by using the generative AI based on the prompts that include the pieces of information on the plurality of items (Step S3). The generation information is generated for each of the target prompts as described above, and, in the target service, the generation information on each of the target prompts is provided at equal probability or in accordance with a predetermined rule, for example.

The information processing apparatus 1 transmits, to the terminal apparatus 2, the generation information that is selected randomly or in accordance with a predetermined rule from among a plurality of pieces of generation information that are generated by using the generative AI for example, and provides each piece of the generation information that is generated by using the generative AI to the user U.

For example, when the target service is the advertisement distribution service, the information processing apparatus 1 transmits, to the terminal apparatus 2, an advertisement content that is selected randomly or in accordance with a predetermined rule from among a plurality of advertisement contents, and provides each of advertisement contents that are generated by using the generative AI to the user U.

Subsequently, the information processing apparatus 1 acquires, from an external information processing apparatus, evaluation information that is information indicating evaluation on the target service using each piece of the generation information that is generated by using the generative AI (Step S4). The evaluation on the target service is at least one of evaluation that is made by the user U who uses the target service and evaluation that is based on a behavior of the user U who uses the target service.

For example, when the generation information that is generated by the generative AI is an advertisement content, the evaluation information is information indicating an index value that is a value of an indicator of advertising effectiveness. The index value is evaluation based on a behavior of the user U who uses the advertisement distribution service, and is, for example, a Conversion Rate (CVR), a Click Through Rate (CTR), or the like.

At Step S4, the information processing apparatus 1 is able to acquire the index value that indicates the advertising effectiveness of the advertisement content for each context of the user U. The context of the user U is a context at the time the information processing apparatus 1 provides the advertisement content to the user U. The context of the user U is a current situation of the user U, a surrounding situation of the user U, or the like.

For example, the context of the user U includes the attribute of the user U, a current location of the user U, a current time, a physical environment of the user U, a social environment of the user U, an exercise condition of the user U, an emotion of the user U, or the like. Examples of the attribute of the user U include a demographic attribute and a psychographic attribute.

The demographic attribute is a demographic attribute, and includes a plurality of attribute items, such as an age, gender, an occupation, a place of residence, an annual salary, and a family structure. The psychographic attribute is a psychological attribute, and includes a plurality of attribute items, such as an interest, a lifestyle, and values. When the attribute is the demographic attribute, the attribute of the user U is, for example, gender, an age (age group), a place of residence, an occupation, or a combination of two or more of the above-described attributes, but embodiments are not limited to this example.

The physical environment of the user U is, for example, temperature, humidity, weather, illuminance, indoor, outdoor, or a combination of two or more of the above-described attributes, but embodiments are not limited to this example. The social environment of the user U is, for example, an economic situation, a political situation, a trendy product, a trendy service, or a combination of two or more of the above-described attributes, but embodiments are not limited to this example.

The exercise condition of the user U is, for example, running, walking, sitting, or the like, but embodiments are not limited to this example. Further, the emotion of the user U is, for example, a smiling state, an angry state, a worrying state, or the like, but embodiments are not limited to this example.

Meanwhile, the context of the user U may be, for example, a combination of two or more of the followings: the attribute of the user U, the current location of the user U, the current time, the physical environment of the user U, the social environment of the user U, the exercise condition of the user U, and the emotion of the user U.

Meanwhile, the information processing apparatus 1 is able to determine the evaluation on the service using the generation information that is generated by the generative AI, instead of the external information processing apparatus. For example, the information processing apparatus 1 acquires information that indicates whether or not the advertisement content is clicked, information that indicates whether or not a target product of the advertisement content is purchased, or the like from the terminal apparatus 2 of the user U, the external information processing apparatus, or the like, and calculates the index value of each of the advertisement contents based on the acquired information.

Subsequently, the information processing apparatus 1 estimates, based on the evaluation information that is acquired at Step S4, degrees of importance of the plurality of items for which the pieces of information are included in the plurality of target prompts that are used by the generative AI at Step S1 (Step S5).

For example, the information processing apparatus 1 estimates the degree of importance of each of the items for which the pieces of information are included in the plurality of target prompts, based on the evaluation information on each piece of the generation information that is generated by using the plurality of target prompts each including a different combination of pieces of information on a plurality of items.

For example, the information processing apparatus 1 estimates the degree of importance of each of the items by regression analysis, a machine learning algorithm, or the like. Examples of the machine learning algorithm include Gradient boosting, such as extreme Gradient (XG) boosting, and a neural network.

The information processing apparatus 1 estimates the degree of importance of each of the items for which the pieces of information are included in the plurality of target prompts, by using regression analysis, a machine learning algorithm, or the like while adopting the evaluation value as a dependent variable (label) and each of the items as an independent variable (feature amount), for example.

The information processing apparatus 1, when acquiring the index value that represents the advertising effectiveness of the advertisement content for each context of the user U for example, is able to estimate, for each context of the user U, the degree of importance of each of the items for which the pieces of information are included in the plurality of target prompts.

When the pieces of information on the plurality of items that are included in the target prompts are not determined at Step S1, the information processing apparatus 1 is able to identify the pieces of information on the plurality of items that are included in the target prompts at Step S5. For example, the information processing apparatus 1 extracts the pieces of information on the plurality of items from each of the target prompts by using the dictionary, the generative AI, or the lie as described above.

The case in which the pieces of information on the plurality of items that are included in the target prompts are not determined at Step S1 is, for example, a case in which, when the prompts that are included in the prompt determination request are determined as the target prompts, a prompt that is generated by the generative AI is determined as a target prompt.

Furthermore, the information processing apparatus 1 is able to calculate the degree of importance for each item combination that is a combination of a plurality of different items. Even in this case, the information processing apparatus 1 estimates the degree of importance for each combination of the plurality of different items by regression analysis, the machine learning algorithm, or the like.

Moreover, when the evaluation information that is acquired at Step S4 is the evaluation information for each context of the user U, the information processing apparatus 1 is able to estimate the degree of importance of each of the items, the degree of importance of each combination of two or more items, or the like, for each context of the user U.

Subsequently, the information processing apparatus 1 selects pieces of information on one or more items that are to be included in a new prompt from among the pieces of information on the plurality of items, based on the degree of importance of each of the items estimated at Step S5 (Step S6). In the following, an item to be included in the new prompt may be described as an extraction item.

For example, the information processing apparatus 1 is able to select, as one or more extraction items that are to be included in a new prompt, items for which the degrees of importance are equal to or larger than a threshold from among the plurality of items for each of which the degree of importance is estimated at Step S5.

Furthermore, the information processing apparatus 1 is able to select, as one or more extraction items that are to be included in a new prompt, m items in order from the highest degree of importance from among the plurality of items for each of which the degree of importance is estimated at Step S5. m is an integer equal to or larger than one.

Moreover, the information processing apparatus 1 is able to select, as one or more extraction items that are to be included in a new prompt, items that are included in an item combination for which the degree of importance is equal to or larger than a threshold from among the item combinations for each of which the degree of importance is estimated at Step S5, instead of or in addition to the items for which the degrees of importance are equal to or larger than the threshold.

Furthermore, the information processing apparatus 1 is able to select, as one or more extraction items that are to be included in a new prompt, items that are included in an item combination for which the degree of importance is high from among the item combinations for each of which the degree of importance is estimated at Step S5, instead of or in addition to m items in order from the highest degree of importance. n is an integer equal to or larger than one.

Subsequently, the information processing apparatus 1 generates 1 a new prompt that includes the pieces of information on one or more extraction items that are selected at Step S6 (Step S7). For example, the information processing apparatus 1 generates, as the new prompt, a prompt that includes the pieces of information on one or more extraction items that are selected at Step S6 and instruction information for instructing generation of generation information using the pieces of information on one or more extraction items.

For example, it is assumed that the one or more extraction items that are selected at Step S6 are the item of “interior design of store”, the item of “store category”, and the character string of “local community” among the item of “interior design of store”, the item of “store condition”, the item of “store category”, and the character string of “local community”.

In this case, the pieces of information on one or more extraction items that are selected at Step S6 are the information on the character string of “cozy interior”, the information on the character string of “organic coffee shop”, and the information on the character string of “local community”.

The information processing apparatus 1 generates, as the new prompt, a prompt that includes, for example, information on a character string of “Please create an advertisement content with information on following items” as the instruction information and includes the pieces of information on one or more extraction items that are selected at Step S6.

Furthermore, the information processing apparatus 1 is able to generate the new prompt by eliminating other than the pieces of information on the extraction items from the pieces of information on the plurality of items that are included in an original prompt. For example, it is assumed that the original prompt is the information on the character string of “Please create an advertisement content for an organic coffee shop that has cozy interior and that is to be newly opened, where the advertisement content has a design targeted for local community”, and the character string of “newly opened” is not the information on the extraction item.

In this case, the information processing apparatus 1 is able to generate, as the new prompt, information on a character string of “Please create an advertisement content for an organic coffee shop that has cozy interior, where the advertisement content has a design targeted for local community.”

Moreover, the information processing apparatus 1 is able to cause the generative AI to generate a new prompt by inputting, to the generative AI, information that includes the original prompt, information on an item other than the extraction items, and the instruction information for instructing generation of a new prompt while eliminating the information on the item other than the extraction items with reference to the original prompt, for example.

Subsequently, the information processing apparatus 1 generates the generation information by using the generative AI based on the new prompt that is generated at Step S7 (Step S8). For example, the information processing apparatus 1 inputs, as the input information, information including the new prompt that is generated at Step S7 to the generative AI, and causes the generative AI to generate generation information corresponding to the input information.

Subsequently, the information processing apparatus 1 provides the target service using the generation information that is generated at Step S8 (Step S9). The information processing apparatus 1 transmits the generation information that is generated by the generative AI to the terminal apparatuses 2, and provides the generation information that is generated by using the generative AI to the user U, for example.

Meanwhile, in the example as described above, the information processing apparatus 1 determines, as the target prompt, each of prompts each including a different combination of the pieces of information on the plurality of items; however, it is possible to determine, as the target prompt, each of prompts including two or more prompts each including pieces of information on a plurality of same items.

Furthermore, in the example as described above, the information processing apparatus 1 is able to determine, as the target prompt, a single prompt instead of or in addition to determining each of the prompts as the target prompts.

In this case, the information processing apparatus 1 inputs, as the input information, information including the determined single target prompt to the generative AI, causes the generative AI to generate generation information corresponding to the input information, and provide a target service that is a service using the generation information to the plurality of users U. The information processing apparatus 1 acquires, from an external information processing apparatus, evaluation information that is information indicating evaluation that is made by each of the users U on the provided target service, and estimates the degrees of importance of the plurality of items based on the acquired evaluation information.

The information indicating evaluation made by the user U is, for example, information indicating a comment that represents evaluation on the target service, or information indicating evaluation that is made by the user U on the plurality of items that are included in the target prompts. The information processing apparatus 1 estimates degrees of importance of the plurality of items that are included in the target prompts based on, for example, the information indicating the comment that represents the evaluation on the target service or the information indicating the evaluation that is made by the user U on the plurality of items that are included in the target prompts.

For example, the information processing apparatus 1 is able to input, to the generative AI, information that includes information indicating a comment that represents evaluation on the target service and information for instructing estimation of the degrees of importance of the plurality of items that are included in the target prompts from the information indicating the comment, and cause the generative AI to estimate the degrees of importance of the plurality of items that are included in the target prompts.

Furthermore, the information processing apparatus 1 estimates the degrees of importance of the plurality of items that are included in the target prompts such that the item with higher evaluation has a higher degree of importance, based on the information indicating evaluation that is made by the user U on the plurality of items that are included in the target prompts.

Moreover, the information processing apparatus 1 is able to, in addition to inputting, to the generative AI, information that includes a single target prompt and causing the generative AI to generate the generation information, input, to the generative AI, information that includes a plurality of target prompts as a single piece of input information and cause the generative AI to generate the generation information.

In this manner, the information processing apparatus 1 acquires the evaluation information that is information indicating evaluation on the target service using the generation information that is information generated by using the generative AI based on the prompts that include the pieces of information on the plurality of items, and estimates the degrees of importance of the plurality of items based on the acquired evaluation information. With this configuration, the information processing apparatus 1 is able to support optimization of a prompt with increased accuracy.

Furthermore, the information processing apparatus 1 generates a new prompt that includes information on one or more items that are selected based on the estimated degrees of importance of the plurality of items, and provides a target service by using the generation information that is information that is generated by using the generative AI based on the generated new prompt. With this configuration, the information processing apparatus 1 is able to provide information using the new prompt that is optimized with increased accuracy.

A configuration of an information processing system that includes the information processing apparatus 1 and the plurality of terminal apparatuses 2 that perform the processes as described above will be described in detail below.

### 2. Configuration of Information Processing System

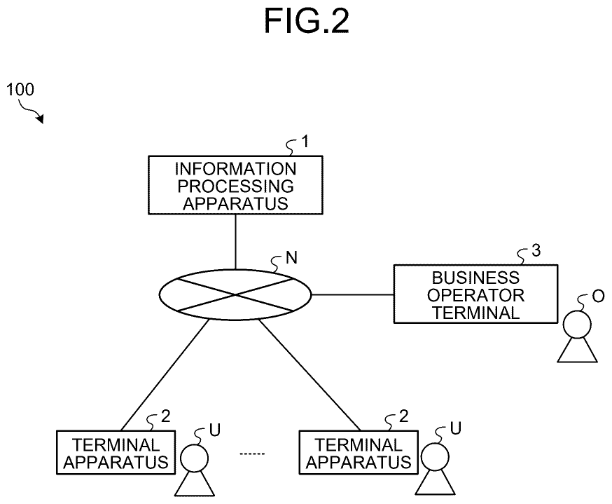

FIG. 2 is a diagram illustrating an example of a configuration of an information processing system according to one embodiment. As illustrated in FIG. 2, an information processing system 100 according to one embodiment includes the information processing apparatus 1, the plurality of terminal apparatuses 2, and a business operator terminal 3.

The plurality of terminal apparatuses 2 are used by different users U. Each of the terminal apparatuses 2 is, for example, a notebook Personal Computer (PC), a desktop PC, a smartphone, a tablet PC, or a wearable device. The wearable device is, for example, smart glasses, a smart watch, or the like, but is not limited to this example.

The business operator terminal 3 is a terminal apparatus of a business operator O, and is, for example, a notebook PC, a desktop PC, a smartphone, a tablet PC, or the like, but is not limited to this example. The business operator O is an advertiser or an advertisement creator when the service that is provided by the information processing apparatus 1 is the advertisement distribution service.

The information processing apparatus 1, the terminal apparatuses 2, and the business operator terminal 3 are communicably connected to one another via a network N in a wired or wireless manner. Meanwhile, the information processing system 100 illustrated in FIG. 2 may include the plurality of information processing apparatuses 1 and the plurality of business operator terminals 3.

The network N includes, for example, a Wide Area Network, such as the Internet, a mobile communication network, such as Long Term Evolution (LTE), 4th Generation Mobile Communication System (4G), or 5th Generation Mobile Communication System (5G).

The terminal apparatuses 2 and the business operator terminal 3 are able to connect to the network N via a near field wireless communication, such as a mobile communication network, Bluetooth (registered trademark), or a wireless Local Area Network (LAN), and communicate with the information processing apparatus 1 or the like.

### 3. Configuration of Information Processing Apparatus 1

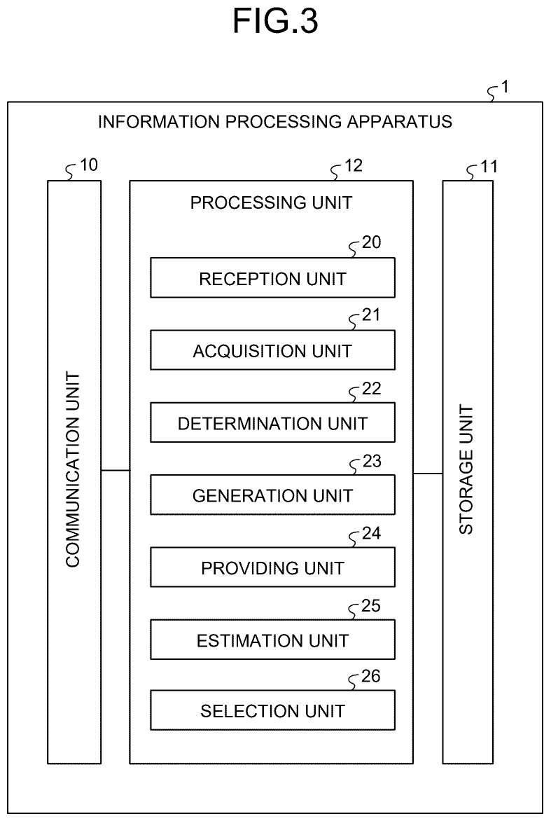

FIG. 3 is a diagram illustrating an example of a configuration of the information processing apparatus 1 according to one embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a Network Interface Card (NIC), or the like. Further, the communication unit 10 is connected to the network N in a wired or wireless manner and transmits and receives information to and from various other apparatuses. For example, the communication unit 10 transmits and receives information to and from the terminal apparatuses 2 and the business operator terminal 3 via the network N.

### 3.2. Storage Unit 11

The storage unit 11 is implemented by, for example, a semiconductor memory device, such as a Random Access Memory (RAM) or a Flash Memory, or a storage device, such as a hard disk or an optical disk.

### 3.3. Processing Unit 12

The processing unit 12 is a controller, and implemented by, for example, causing a processor, such as a Central Processing Unit (CPU) or a Micro Processing Unit (MPU), to execute various kinds of programs (corresponding to one example of an information processing program) that are stored in a storage device in the information processing apparatus 1 by using a RAM or the like as a work area.

Further, the processing unit 12 is a controller, and may be implemented by, for example, an integrated circuit, such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 20, an acquisition unit 21, a determination unit 22, a generation unit 23, a providing unit 24, an estimation unit 25, and a selection unit 26, and implements or performs functions and operation of information processing as described below. Meanwhile, an internal configuration of the processing unit 12 is not limited to the configuration illustrated in FIG. 3, and it is possible to adopt a different configuration as long as the information processing to be described below is performed.

### 3.3.1. Reception Unit 20

The reception unit 20 receives various kinds of information and requests via the network N and the communication unit 10. For example, the reception unit 20 receives various kinds of requests that are transmitted from the terminal apparatuses 2 via the network N and the communication unit 10.

For example, when a target service that is provided by the providing unit 24 is an advertisement distribution service, the reception unit 20 receives the advertisement distribution request that is transmitted from the terminal apparatuses 2. Further, when the target service is an electronic commerce service, the reception unit 20 receives a transmission request for a store page or a product page, which is transmitted from the terminal apparatuses 2. The advertisement distribution request, the transmission request for the store page, and the transmission request for the product page are examples of a services provision request from the user U.

Furthermore, when the target service is a text proofreading service, the reception unit 20 receives a text proofreading request that is transmitted from the terminal apparatuses 2. Moreover, when the target service is an online learning service, a learning support request that is transmitted from the terminal apparatuses 2 is received. The text proofreading request and the learning support request are examples of a service provision request that is issued from the user U. The online learning service is a service for exchanging information with the user U in a chat format to support learning of the user U.

Furthermore, the reception unit 20 receives various kinds of requests that are transmitted from the business operator terminal 3 via the network N and the communication unit 10. For example, the reception unit 20 receives a prompt determination request that is transmitted from the business operator terminal 3.

### 3.3.2. Acquisition Unit 21

The acquisition unit 21 acquires various kinds of information from an external apparatus or the like via the network N and the communication unit 10, or acquires various kinds of information from the storage unit 11.

For example, the acquisition unit 21 acquires evaluation information, which is information that indicates evaluation on the target service using a plurality of pieces of generation information that are information generated by using the generative AI based on the plurality of prompts including the pieces of information on the plurality of items, from the terminal apparatuses 2, an external information processing apparatus, or the like. The evaluation on the target service is one or more of evaluation that is made by the user U who uses the target service and evaluation that is based on a behavior of the user U who uses the target service.

When the generation information that is generated by the generative AI is an advertisement content, the evaluation information is information indicating an index value that is a value of an indicator of advertising effectiveness. The index value is evaluation based on a behavior of the user U who uses the advertisement distribution service, and is, for example, a CVR, a CTR, or the like.

Furthermore, when the generation information that is generated by the generative AI is the store page or the product page, the evaluation information is, for example, information indicating evaluation that is made by the user U who has visited the store page or the product page, or a CVR indicating a rate of purchase of a product by the user U who has visited the store page or the product page.

The information indicating evaluation that is made by the user U is, for example, information indicating an evaluation made by the user U on a store or a product, and is, for example, an evaluation value that is represented by five-stage rating from 1 to 5. In this case, the evaluation information is, for example, an average value or a median value of evaluation values that are given by the user U.

Furthermore, when the generation information that is generated by the generative AI is a proofreading result, the evaluation information is information that indicates evaluation made by the user U who has checked the proofreading result on the text proofreading service. In this case, the evaluation information is, for example, an average value or a median value of evaluation values that are given by the user U.

Moreover, when the generation information that is generated by the generative AI is a query or an answer, the evaluation information is information that indicates evaluation made by the user U who has checked the proofreading result on the online learning service. In this case, the evaluation information is, for example, an average value or a median value of evaluation values that are given by the user U.

The acquisition unit 21 is able to acquire the evaluation information for each context of the user U. The context of the user U is a context at the time the providing unit 24 provides the advertisement content to the user U. The context of the user U is a current situation of the user U, a surrounding situation of the user U, or the like.

For example, the context of the user U includes the attribute of the user U, the current location of the user U, the current time, the physical environment of the user U, the social environment of the user U, the exercise condition of the user U, the emotion of the user U, or the like. The attribute of the user U is, for example, a demographic attribute, a psychographic attribute, or the like.

The demographic attribute is a demographic attribute, and includes a plurality of attribute items, such as an age, gender, an occupation, a place of residence, an annual salary, and a family structure. The psychographic attribute is a psychological attribute, and includes a plurality of attribute items, such as an interest, a lifestyle, and values. When the attribute is the demographic attribute, the attribute of the user U is, for example, gender, an age (age group), a place of residence, an occupation, or a combination of two or more of the above-described attributes, but embodiments are not limited to this example.

The physical environment of the user U is, for example, temperature, humidity, weather, illuminance, indoor, outdoor, or a combination of two or more of the above-described attributes, but embodiments are not limited to this example. The social environment of the user U is, for example, an economic situation, a political situation, a trendy product, a trendy service, or a combination of two or more of the above-described attributes, but embodiments are not limited to this example.

The exercise condition of the user U is, for example, running, walking, sitting, or the like, but embodiments are not limited to this example. Further, the emotion of the user U is, for example, a smiling state, an angry state, a worrying state, or the like, but embodiments are not limited to this example.

Meanwhile, the context of the user U may be, for example, a combination of two or more of the followings: the attribute of the user U, the current location of the user U, the current time, the physical environment of the user U, the social environment of the user U, the exercise condition of the user U, and the emotion of the user U.

The acquisition unit 21 acquires information that is included in a request that is received by the reception unit 20. For example, the reception unit 20 acquires is included in the prompt determination request that is received by the reception unit 20.

Furthermore, the acquisition unit acquires, from the terminal apparatuses 2, an external information processing apparatus, or the like, information indicating a comment that represents evaluation on the target service using the generation information that is generated based on the target prompts or information indicating evaluation that is made by the user U on the plurality of items that are included in the target prompts.

### 3.3.3. Determination Unit 22

The determination unit 22 determines, as the target prompt, a single prompt that includes pieces of information on a plurality of items, or determines, as the target prompt, each of prompts including pieces of information on a plurality of items.

For example, the determination unit 22 determines, as the target prompt, each of prompts each including a different combination of the pieces of information on the plurality of items. The plurality of target prompts include, for example, different combinations of pieces of information on a plurality of items.

Each of the items included in the target prompts is an item that indicates a type of a key matter or a characteristic matter, and is, for example, an item that indicates a semantic type, such as a semantic field. Further, the information on the item is information that indicates a content of the key matter, information that indicates a content of the characteristic matter, or the like.

The target prompt is information that is be input to the generative AI as described above for generating provision information that is information to be provided to the user U in the target service that is provided by the providing unit 24.

When the target service is the advertisement distribution service, the prompt that is determined by the determination unit 22 is information that is to be input to the generative AI (to be described later) for causing the generative Ai to generate, as the generation information, an advertisement content that is provided by the advertisement distribution service. The advertisement content is, for example, a content that includes at least one of text and an image.

Furthermore, when the target service is an electronic commerce service, the prompt that is determined by the determination unit 22 is information that is to be input to the generative AI for causing the generative AI to generate, as the generation information, a store page or a product page that is provided by the electronic commerce service.

Moreover, when the target service is a text proofreading service, the prompt that is determined by the determination unit 22 is information that is to be input to the generative AI for causing the generative AI to generate information that indicates a proofreading result with respect to a sentence that is included in the text proofreading request that is received by the reception unit 20.

Furthermore, when the target service is an online learning service, the prompt that is determined by the determination unit 22 is information that is to be input to the generative AI for causing the generative AI to generate information indicating information corresponding to the learning support request that is received by the reception unit 20.

When the determination unit 22 determines the plurality of target prompts, the plurality of target prompts are prompts related to the same target; however, the plurality of prompts may be prompts that are related to different targets or a part of the prompts may be related to different targets. For example, when the target service is the advertisement distribution service, the same target is, for example, a specific landing page, and the plurality of targets are a plurality of specific landing pages.

Furthermore, when the target service is an electronic commerce service, the same target is, for example, the same product or the same service, and the plurality of targets are a plurality of products or a plurality of services. Moreover, when the target service is a text proofreading service, the same target is, for example, a sentence of the same category, and the plurality of targets are a plurality of sentences of a plurality of categories. Furthermore, when the target service is an online learning service, the same target is, for example, the same subject, and the plurality of targets are a plurality of subjects.

A case will be described below in which the target service is the advertisement distribution service. A prompt to be input to the generative AI for generating, as the generation information, an advertisement content that is to be provided by the advertisement distribution service is, for example, the information on the character string of “Please create an advertisement content for an organic coffee shop that has cozy interior and that is to be newly opened, where the advertisement content has a design targeted for local community.”

Furthermore, the pieces of information on the plurality of items are the information on the character string of “cozy interior”, the information on the character string of “newly opened”, the information on the character string of “organic coffee shop”, the information on the character string of “local community”, and the like.

The information on the character string of “cozy interior” is information on the item of “interior design of store”, the character string of “newly opened” is the item of “store condition”, the information on the character string of “organic coffee shop” is the information on the item of “store category”, and the information on the character string of “local community” is the information on the item of “place of residence of target user”. The information on the item of “place of residence of target user” is one example of the information that indicates the attribute of the target user U.

Meanwhile, the information on the item is not limited to the examples as described above, and may be, for example, the information on the item of “place of store”, the information on the item of “event”, the information on the item of “coupon discount”, the information on the item of “product price”, the information on the item of “age group of target user”, the item of “interest of target user”, or the like.

Furthermore, in the example as described above, the advertisement content of the real store is described as one example, but the advertisement content is not limited to the advertisement content of the real store. For example, the advertisement content may be an advertisement content of a virtual store in an electronic commerce site, an advertisement content of a product that is sold in a real store or a store, or other advertisement contents.

A case will be described below in which the target service is the text proofreading service. A prompt to be input to the generative AI for generating, as the generation information, a proofreading result that is to be provided by the text proofreading service is, for example, information on a character string of “You are a professional proofreader, and detect typographical errors, inconsistent spelling, and other errors in input sentences. A maximum number of detections will be 20. Please carefully check each sentence. An output format is the followings: \n {error type} \n<true> {uncorrected error} \n<false> {corrected error} \n\n {error type} is a character string indicating an error type, {unrevised error} is a character string indicating a sentence before error, and {corrected error} is a character string indicating a corrected sentence.”

Information on a character string of “You are a professional proofreader” is information on an item of “role of AI”, information on a character string of “detect typographical errors, inconsistent spelling, and other errors in input sentences” is information on an item of “detection target”, information on a character string of “A maximum number of detections will be 20” is information on an item of “number of detections”, and information on a character string of “Please carefully check each sentence” is information on an item of “detection procedure”.

Further, a character string of “An output format is the followings: \n {error type} \n<true> {uncorrected error} \n<false> {corrected error} \n\n {error type} is a character string indicating an error type, {uncorrected error} is a character string indicating a sentence before error, and {revised error} is a character string indicating a revised sentence” is information on an item of “output format”.

Meanwhile, the information on the item of “output format” may be information on subdivided items. For example, it may be possible to adopt information on an item of “output format-error type”, information on an item of “output format-error details”, information on an item of “output format-correction details”, or it may be possible to include information on an item of “output format-detection reason” or the like.

A case will be described below in which the target service is the online learning service. A prompt to be input to the generative AI for generating, as the generation information, information that indicates a query and an answer that are to be provided by the online learning service is, for example, information on a character string of “You are a professional teacher, and provide a user with an educational service following below steps under the following constraints. \n ###constraints \n1. Meet needs of each learner: provide training that is customized in accordance with a knowledge level, an interest, and a learning style of a learner\n2, Adhere to educational principles: based on a training method including educational accuracy and understanding . . . \n steps\n1. Understand a learning objective of a user: check a topic and an objective of learning by the user\n2. Generate a customized learning plan: generate an individual learning plan based on needs and the objective of the user . . . ”.

Information on a character string of “You are a professional teacher” is the information on the item of “role of AI”, information on a character string of “1. Meet needs of each learner: . . . ” is information on an item of “constraints-meet needs”, information on a character string of “2. Adhere to educational principles: . . . ” is information on an item of “constraints-educational principles”, . . . , information on a character string of “1. Understand a learning objective of a user: . . . ” is information on an item of “step-understanding of objective”, . . . , and information on a character string “2. Generate a customized learning plan: . . . ” is information on an item of “step-generation of learning plan etc.”

The information on the item is not limited to the examples as described above, and may be, for example, the information on the item of “tone of speech”, the information on the item of “prompt format”, or the like. The information on the item of “tone of speech” is, for example, information on a direct instruction, such as “do”, or an indirect instruction, such as “please”. The item of ““prompt format” is information on, for example, Zero-shot, One-shot, or Few-shot.

The determination unit 22, when receiving the prompt determination request that is transmitted from the business operator terminal 3 for example, extracts pieces of information on a plurality of items from among pieces of information that are included in the prompt determination request. Further, the determination unit 22 determines, as the plurality of target prompts as described above, a plurality of prompts each including a different combination of pieces of information on two or more items from among the extracted pieces of information on the plurality of items.

The determination unit 22 has dictionary information that includes, for example, a plurality of terms for each of the items, and is able to extract pieces of information on a plurality of items from among the pieces of information that are included in the prompt determination request by using the dictionary information. Further, the determination unit 22 is able to extract pieces of information on a plurality of items from among the pieces of information that are included in the prompt determination request by using text generative AI, such as Large Language Models.

Furthermore, the determination unit 22 is able to transmit, for example, the template information for allowing a user to input or select pieces of information on a plurality of items that are determined in advance to the business operator terminal 3, and cause the business operator terminal 3 to display the template information. In this case, the business operator O is able to input or select the pieces of information on the plurality of items by operating the business operator terminal 3, and accordingly, the prompt determination request that includes the pieces of information on the plurality of items is transmitted from the business operator terminal 3 to the information processing apparatus 1.

The prompt determination request that is transmitted from the business operator terminal 3 may include information that is needed to generate a prompt including the pieces of information on the plurality of items, instead of the template information. For example, when the target service is the online learning service, it may be possible to include a landing page that is a target of an advertisement. In this case, the determination unit 22 is able to extract the pieces of information on the plurality of items from the landing page that is identified by the prompt determination request, by using the dictionary, the generative AI, or the like as described above. The determination unit 22 determines, as the plurality of target prompts as described above, a plurality of prompts each including a different combination of pieces of information on two or more items from among the extracted pieces of information on the plurality of items.

Meanwhile, the target prompt may be, for example, a prompt that is generated by using the generative AI. Further, the target prompt is not limited to a character prompt, but may include, for example, image data in addition to the character prompt.

The information on the item included in the target prompt is not limited to the information on the item included in the character prompt, and may include, for example, information that indicates a type of the image represented by the image data or information on an item that is included in the image represented by the image data. The information on the item that is included in the image represented by the image data may be an object, a scene, an emotion, a color, or the like that is illustrated in the image represented by the image data, but embodiments are not limited to this example.

Meanwhile, when the prompt determination request includes a plurality of prompts, the determination unit 22 is able to determine the prompts that are included in the prompt determination request as a plurality of target prompts.

### 3.3.4. Generation Unit 23

The generation unit 23 performs a process of inputting, as input information, the information including a target prompt that is a prompt including the pieces of information on the plurality of items that are determined by the determination unit 22 to a generative AI, and causing the generative AI to generate generation information corresponding to the input information.

When the determination unit 22 determines a plurality of target prompts, the generation unit 23 performs a process of inputting, as the input information, information including the target prompts to the generative AI, and causing the generative AI to generate generation information corresponding to the input information for each of the target prompts.

Furthermore, when the determination unit 22 determines a plurality of target prompts, the generation unit 23 is able to perform a process of inputting, as the input information, information including two or more target prompts among the plurality of target prompts to the generative AI, and causing the generative AI to generate generation information corresponding to the input information.

Moreover, when the determination unit 22 determines a single target prompt, the generation unit 23 performs a process of inputting, as the input information, information including the single target prompt to the generative AI, and causing the generative AI to generate generation information corresponding to the input information.

Examples of the generative AI include text generative AI, image generative AI, and multimodal generative AI. The text generative AI is, for example, Large Language Models that are trained to estimate and output a next token from an input token string, and is, for example, a transformer-based model or an RNN-based model, or may be a model in which the above-described models are mixed. Further, the text generative AI may be a complex system that includes an identification machine for prevention of misuse.

Examples of the transformer-based model include a GPT and PaLM2, but embodiments are not limited to this example. Examples of the RNN-based model include an RWKV, but embodiments are not limited to this example.

The image generative AI is AI that generates an image from text, and is, for example, StackGAN, AttnGAN, T2I with Transformers, a Diffusion model, or the like, but embodiments are not limited to this example. Examples of the Diffusion model include DALL-E and Stable-Diffusion.

The multimodal generative AI is, for example, generative AI that generates at least one of text, an image, and audio from at least one of text, an image, and audio. Examples of the multimodal generative AI include GPT-4 Turbo with vision, gemini, and a CM3Leon, but embodiments are not limited to this example.

Meanwhile, it is preferable that the generative AI is trained so as not to include personal information or the like in a generation result. The generative AI is arranged in an external information processing apparatus and the generation unit 23 uses the generative AI via an API that is provided by the external information processing apparatus; however, the generative AI may be arranged in the information processing apparatus 1.

When the target service is the advertisement distribution service or the electronic commerce service, the generation unit 23 performs a process of inputting, as the input information, information including a target prompt that is a prompt including the pieces of information on the plurality of items that are determined by the determination unit 22 to a generative AI, and causing the generative AI to generate generation information corresponding to the input information, for each of the target prompts that are determined by the determination unit 22.

Furthermore, when the target service is the text proofreading service or the online learning service and when receiving the service provision request from the user U, the generation unit 23 inputs, as the input information, information that includes the target prompt, which is selected randomly or in accordance with a predetermined rule from among the plurality of target prompts that are determined by the determination unit 22, and the information that is included in the service provision request to the generative AI, and causes the generative AI to generate generation information corresponding to the input information.

For example, when the target service is the text proofreading service, the information that is included in the service provision request is information that indicates a sentence. Furthermore, when the target service is the online learning service, the information that is included in the service provision request is information on a character string that indicates a query or an answer.

Moreover, the generation unit 23 generates, as a new prompt, a prompt that includes information on one or more items that are selected based on the degrees of importance of the plurality of items that are estimated by the estimation unit 25.

For example, the generation unit 23 generates, as the new prompt, a prompt that includes information on one or more items that are selected by the selection unit 26 based on the degrees of importance of the plurality of items that are estimated by the estimation unit 25. Furthermore, the generation unit 23 is able to generate, as the new prompt, a prompt that includes information on one or more items that are selected by the business operator O based on the degrees of importance of the plurality of items that are estimated by the estimation unit 25, for example.

For example, the generation unit 23 generates, as the new prompt, a prompt that includes the pieces of information on one or more extraction items that are selected by the selection unit 26, and instruction information for instructing generation of generation information using the pieces of information on one or more extraction items.

For example, it is assumed that the one or more extraction items that are selected by the selection unit 26 are the item of “interior design of store”, the item of “store category”, and the character string of “local community” among the item of “interior design of store”, the item of “store condition”, the item of “store category”, and the character string of “local community”.

In this case, the pieces of information on one or more extraction items that are selected by the selection unit 26 are the information on the character string of “cozy interior”, the information on the character string of “organic coffee shop”, and the information on the character string of “local community”.

The generation unit 23 generates, as the new prompt, a prompt that includes, for example, information on a character string of “Please create an advertisement content with information on following items” as the instruction information and includes the pieces of information on one or more extraction items that are selected by the selection unit 26.

Furthermore, the generation unit 23 is able to generate the new prompt by eliminating other than the pieces of information on the extraction items from the pieces of information on the plurality of items that are included in an original prompt. For example, it is assumed that the original prompt is the information on the character string of “Please create an advertisement content for an organic coffee shop that has cozy interior and that is to be newly opened, where the advertisement content has a design targeted for local community”, and the character string of “newly opened” is not the information on the extraction item.

In this case, the generation unit 23 is able to generate, as a new prompt, the information on the character string of “Please create an advertisement content for an organic coffee shop that has cozy interior, where the advertisement content has a design targeted for local community.”

Moreover, the generation unit 23 is able to cause the generative AI to generate a new prompt by inputting, to the generative AI, information that includes the original prompt, information on an item other than the extraction items, and the instruction information for instructing generation of a new prompt while eliminating the information on the item other than the extraction items with reference to the original prompt, for example.

The generation unit 23 inputs, as the input information, information including the generated new prompt to the generative AI, and causes the generative AI to generate generation information corresponding to the input information. When the generation unit 23 generates a plurality of new prompts, the generation unit 23 performs a process of inputting, as the input information, pieces of information including the plurality of new prompts to the generative AI, and causing the generative AI to generate generation information corresponding to the input information for each of the new prompts.

When the selection unit 26 selects one or more extraction items that are to be included in the new prompt for each context of the user U, the generation unit 23 is able to perform a process of inputting, as the input information, information including the generated new prompt to the generative AI, and causing the generative AI to generate generation information corresponding to the input information for each context of the user U.

### 3.3.5. Providing Unit 24

The providing unit 24 provides the target service by using the plurality of pieces of generation information that are piece of information generated by using the generative AI based on the plurality of target prompts. The generation information is generated for each of the target prompts as described above, and, in the target service, the generation information for each of the target prompts is provided at equal probability or in accordance with a predetermined rule, for example.

The providing unit 24 transmits, to the terminal apparatus 2, the generation information that is selected randomly or in accordance with a predetermined rule from among the plurality of pieces of generation information that are generated by using the generative AI for example, and provides each piece of the generation information that is generated by using the generative AI to the user U.

For example, when the target service is the advertisement distribution service, the providing unit 24 transmits, to the terminal apparatus 2, an advertisement content that is selected randomly or in accordance with a predetermined rule from among a plurality of advertisement contents, and provides each of advertisement contents that are generated by using the generative AI to the user U.

Furthermore, when the target service is the electronic commerce service, the providing unit 24 transmits, to the terminal apparatus 2, a store page or a product page that is selected randomly or in accordance with a predetermined rule from among a plurality of store pages or a plurality of product pages, and provides each of the store pages or each of the product pages that are generated by using the generative AI to the user U.

Moreover, when the target service is the text proofreading service, the providing unit 24 transmits, to the terminal apparatus 2, a proofreading result that is generated by using the generative AI for the target prompt that is selected randomly or in accordance with a predetermined rule by the generation unit 23 from among the plurality of target prompts, and provides the proofreading result that is generated by using the generative AI to the user U.

Furthermore, when the target service is the online learning service, the providing unit 24 transmits, to the terminal apparatus 2, information on a query and an answer for the user U, where the information is generated by using the generative AI for the target prompt that is selected randomly or in accordance with a predetermined rule by the generation unit 23 from among the plurality of target prompts, and provides the information on the query and the answer for the user U, which is generated by using the generative AI, to the user U.

Moreover, the providing unit 24 provides the target service by using the generation information that is generated by the generative AI based on the new prompt that is generated by the generation unit 23. For example, the providing unit 24 transmits, to the terminal apparatus 2, the generation information that is generated by the generative AI based on the new prompt that is generated by the generation unit 23, and provides the generation information that is generated by using the new prompt by the generative AI to the user U.

The providing unit 24, by transmitting, to the terminal apparatus 2, the generation information that is generated by the generative AI based on a prompt that is the new prompt generated by the generation unit 23 and that corresponds to the context of the user U, is able to provide the generation information that is generated by the generative AI by using the new prompt and that corresponds to context of the user U to the user U.

When no information is included in the service provision request or when the information included in the service provision request is not used for generation of the generation information, the providing unit 24 is able to provide the same generation information to the plurality of users U. Furthermore, when the information included in the service provision request is used for generation of the generation information, the providing unit 24 is able to provide different generation information for each piece of information included in the service provision request to the user U.

Moreover, when the determination unit 22 determines a single target prompt, the providing unit 24, is able to provide a target service that is a service with the generation information that is provided by the generation unit 23 by using the single target prompt to the plurality of users U.

### 3.3.6. Estimation Unit 25

The estimation unit 25 estimates the degrees of importance of the plurality of items based on the evaluation information that is acquired by the acquisition unit 21.

For example, the estimation unit 25 estimates the degree of importance of each of the items for which the pieces of information are included in the plurality of target prompts, based on the evaluation information on each piece of the generation information that is generated by using the plurality of target prompts each including a different combination of the pieces of information on the plurality of items.

For example, the information processing apparatus 1 estimates the degree of importance of each of the items by regression analysis, a machine learning algorithm, or the like. Examples of the machine learning algorithm include Gradient boosting, such as XG boosting, and a neural network.

The estimation unit 25 estimates a degree of importance of each of the items for which pieces of information are included in the plurality of target prompts, by using regression analysis, a machine learning algorithm, or the like while adopting the evaluation value as a dependent variable (label) and each of the items as an independent variable (feature amount), for example.

The estimation unit 25, when acquiring the index value that represents the advertising effectiveness of the advertisement content for each context of the user U for example, is able to estimate, for each context of the user U, the degree of importance of each of the items for which pieces of information are included in the plurality of target prompts.

When the determination unit 22 has not determined the pieces of information on the plurality of items that are included in the target prompts, the estimation unit 25 is able to identify the pieces of information on the plurality of items that are included in the target prompts. For example, the estimation unit 25 extracts the pieces of information on the plurality of items from each of the target prompts by using the dictionary, the generative AI, or the lie as described above.

The case in which the determination unit 22 has not determined the pieces of information on the plurality of items that are included in the target prompts is, for example, a case in which, when the prompts that are included in the prompt determination request are determined as the target prompts, the determination unit 22 determines a prompt that is generated by the generative AI as a target prompt.

Furthermore, the estimation unit 25 is able to calculate the degree of importance for each item combination that is a combination of a plurality of different items. Even in this case, the estimation unit 25 estimates the degree of importance for each combination of the plurality of different items by regression analysis, the machine learning algorithm, or the like.

Moreover, when the evaluation information that is acquired by the acquisition unit 21 is the evaluation information for each context of the user U, the estimation unit 25 is able to estimate the degree of importance of each of the items, the degree of importance of each combination of two or more items, or the like, for each context of the user U.

Furthermore, when the determination unit 22 determines a single target prompt, the estimation unit 25 estimates the degrees of importance of the plurality of items that are included in the target prompts based on the information indicating a comment that represents evaluation on the target service using the generation information that is generated based on the single target prompt or based on information indicating evaluation that is made by the user U on the plurality of items that are included in the target prompts.

For example, the estimation unit 25 is able to input, to the generative AI, information that includes information indicating a comment that represents evaluation on the target service and information for instructing estimation of the degrees of importance of the plurality of items that are included in the target prompts based on the information indicating the comment, and cause the generative AI to estimate the degrees of importance of the plurality of items that are included in the target prompts.

Furthermore, the estimation unit 25 estimates the degrees of importance of the plurality of items that are included in the target prompts such that the item with higher evaluation has a higher degree of importance, based on the information indicating evaluation that is made by the user U on the plurality of items that are included in the target prompts.

Meanwhile, the estimation unit 25 is able to determine the evaluation on the service using the generation information that is generated by the generative AI, instead of the external information processing apparatus. For example, the acquisition unit 21 of the information processing apparatus 1 acquires information indicating whether or not the advertisement content is clicked, information indicating whether or not a target product of the advertisement content is purchased, or the like from the terminal apparatus 2 of the user U, the external information processing apparatus, or the like, and the estimation unit 25 calculates the index value of each of the advertisement contents based on the information that is acquired by the acquisition unit 21.

### 3.3.7. Selection Unit 26

The selection unit 26 selects the pieces of information on one or more extraction items that are pieces of information on one or more items that are to be included in a new prompt among the pieces of information on the plurality of items, based on the degrees of importance of the plurality of items that are estimated by the estimation unit 25.

For example, the selection unit 26 is able to select, as one or more extraction items that are to be included in a new prompt, items for which the degrees of importance are equal to or larger than a threshold from among the plurality of items for each of which the degree of importance is estimated by the estimation unit 25.

Furthermore, the selection unit 26 is able to select, as one or more extraction items that are to be included in a new prompt, m items in order from the highest degree of importance from among the plurality of items for each of which the degree of importance is estimated by the estimation unit 25. m is an integer equal to or larger than one.

Moreover, the selection unit 26 is able to select, as one or more extraction items that are to be included in a new prompt, items that are included in an item combination for which the degree of importance is equal to or larger than a threshold from among the item combinations for each of which the degree of importance is estimated by the estimation unit 25, instead of or in addition to the items for which the degrees of importance are equal to or larger than the threshold.

Furthermore, the selection unit 26 is able to select, as one or more extraction items that are to be included in a new prompt, items that are included in an item combination for which the degree of importance is high from among the item combinations for each of which the degree of importance is estimated by the estimation unit 25, instead of or in addition to m items in order from the highest degree of importance. n is an integer equal to or larger than one.

Moreover, when the estimation unit 25 estimates the degree of importance of each of the items, the degree of importance of each combination of two or more items, or the like for each context of the user U, the selection unit 26 is able to select one or more extraction items that are to be included in the new prompt by the same method as the processes as described above.

### 4. Flow of Processes

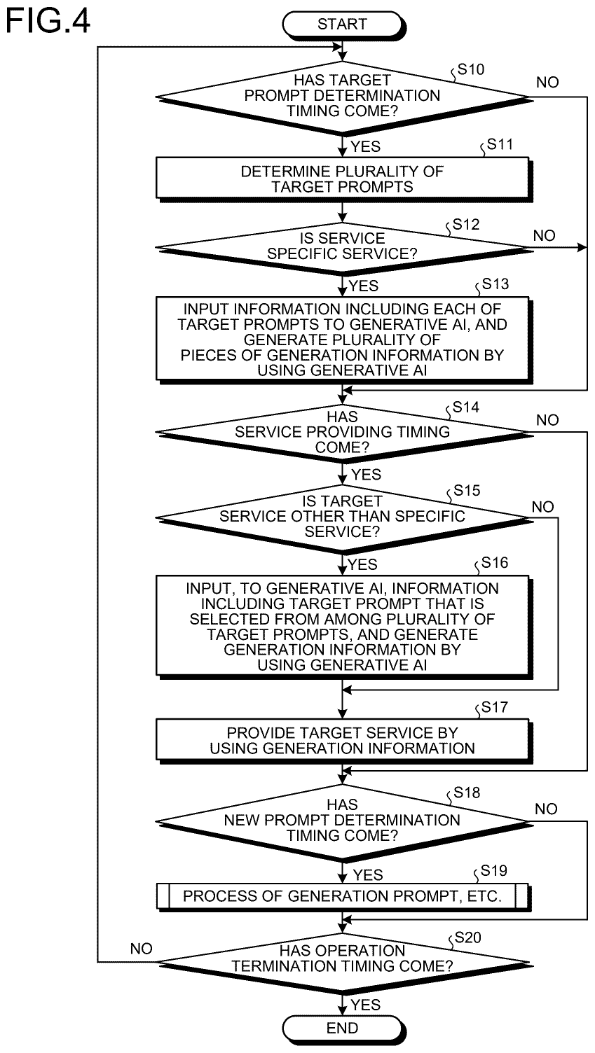

A flow of processes of information processing performed by the processing unit 12 of the information processing apparatus 1 according to one embodiment will be described below. FIG. 4 is a flowchart illustrating an example of the information processing performed by the processing unit 12 of the information processing apparatus 1 according to one embodiment.

As illustrated in FIG. 4, the processing unit 12 of the information processing apparatus 1 determines whether or not a target prompt determination timing has come (Step S10). Examples of the target prompt determination timing include a timing at which a predetermined cycle comes and a timing at which the prompt request that is transmitted from the business operator terminal 3 is received, but embodiments are not limited to this example.

When determining that the target prompt determination timing has come (Step S10: Yes), the processing unit 12 determines a plurality of target prompts (Step S11). Further, the processing unit 12 determines whether or not a target service that is a service for providing the generation information using the target prompts determined at Step S11 is a specific service (Step S12).

Examples of the specific service includes the advertisement distribution service and the electronic commerce service, but embodiments are not limited to this example. Examples of a target service other than the specific service include the text proofreading service and the online learning service, but embodiments are not limited to this example.

When determining that the target service is the specific service (Step S12: Yes), the processing unit 12 inputs, to the generative AI, information including each of the target prompts, and generates a plurality of pieces of generation information by using the generative AI (Step S13).

When the process at Step S13 is terminated, when it is determined that the target service is not the specific service (Step S12: No), or when the target prompt determination timing has not yet come (Step S10: No), the processing unit 12 determines whether or not a service providing timing has come (Step S14). Examples of the service providing timing include a timing at which the service provision request that is transmitted from the terminal apparatus 2 of the user U is received, but embodiments are not limited to this example.

When determining that the service providing timing has come (Step S14: Yes), the processing unit 12 determines whether or not the target service is other than the specific service (Step S15). When determining that the target service is other than the specific service (Step S15: Yes), the processing unit 12 inputs, to the generative AI, information that includes a target prompt that is selected from among the plurality of target prompts, and generates generation information by using the generative AI (Step S16).

When the process at Step S15 is terminated or when it is determined that the target service is not a service other than the specific service (Step S15: No), the processing unit 12 provides the target service by using the generation information that is generated at Step S13 or Step S16 (Step S17).

When the process at Step S17 is terminated or when it is determined that the service providing timing has not yet come (Step S14: No), the processing unit 12 determines whether or not a new prompt determination timing has come (Step S18). Examples of the new prompt determination timing include a timing at which a certain period that is determined in advance elapses since provision of the generation information that is generated by using the target prompt and a timing at which the number of times of provisions of the generation information that is generated by using the target prompt to the user U becomes equal to or larger than a certain number that is determined in advance, but embodiments are not limited to this example.

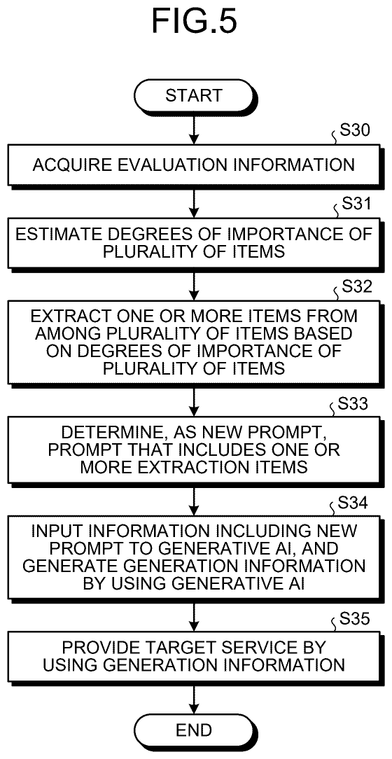

When determining that the new prompt determination timing has come (Step S18: Yes), the processing unit 12 performs a process of generating a prompt or the like (Step S19). The process at Step S19 is the processes from Step S30 to S35 illustrated in FIG. 5, which will be described in detail later.

When the process at Step S19 is terminated or when it is determined that the new prompt determination timing has not yet come (Step S18: No), the processing unit 12 determines whether or not an operation termination timing has come (Step S20). The processing unit 12 determines that the operation termination timing has come when, for example, a power supply of the information processing apparatus 1 is turned off.

When determining that the operation termination timing has not yet come (Step S20: No), the processing unit 12 moves to a process at Step S10, and when determining that the operation termination timing has come (Step S20: Yes), the processing unit 12 terminates the process illustrated in FIG. 4.

FIG. 5 is a flowchart illustrating an example of the process of generating a prompt or the like by the processing unit 12 of the information processing apparatus 1 according to one embodiment. As illustrated in FIG. 5, the processing unit 12 acquires evaluation information that is information indicating evaluation on the target service using the plurality of pieces of generation information that are pieces of information that are generated by using the generative AI based on the plurality of target prompts including the pieces of information on the plurality of items (Step S30).

Subsequently, the processing unit 12 estimates the degrees of importance of the plurality of items based on the evaluation information that is acquired at Step S30 (Step S31). Further, the processing unit 12 extracts one or more items from among the plurality of items based on the degrees of importance of the plurality of items that are estimated at Step S31 (Step S32).

Subsequently, the processing unit 12 determines, as a new prompt, a prompt that includes the one or more extraction items that are extracted at Step S32 (Step S33). Further, the processing unit 12 inputs, to the generative AI, information including the new prompt that is generated at Step S33, and generates generation information by using the generative AI (Step S34). The processing unit 12 provides the target service by using the generation information that are generated at Step S34 (Step S35), and terminates the process illustrated in FIG. 5.

### 5. Modification

The target service is not limited to the examples as described above, and may be, for example, a sentence creation service, a sentence summarizing service, or a programming support service.

In the example as described above, the information indicating the evaluation on the target service is, for example, an evaluation value that is represented by five-stage rating from 1 to 5, but may be an evaluation value that is represented by four or less stages or an evaluation value that is represented by six or more stages. Furthermore, the information indicating the evaluation on the target service may be, for example, the number of posts, re-posts, or the like in X (ex-Twitter), or may be an evaluation value that is calculated based on a review given by the user U.

Moreover, in the example as described above, the generation unit 23 inputs, as the input information, information including a prompt to the generative AI, and causes the generative AI to generate generation information, but embodiments are not limited to this example. For example, the generation unit 23 may input, as the input information, the information including the prompt to the generative AI, and generate the generation information based on information that is output from the generative AI.

For example, the prompt may be a prompt that includes intent definition information for extracting an intent type and an intent content. The intent definition information includes, for example, instruction information that includes an instruction to extract the intent type and the intent content from user setting information, and definition information that includes the intent type and information for defining the intent type. The generation unit 23 is able to cause the generative AI to generate the intention information by using a function of function calling when, for example, using an API that is provided by OpenAI (registered trademark).

The intent type is, for example, a type of intent of the additional information, and the information indicating the intent type is, for example, information for identifying a mathematical function or a function in accordance with the intent type. Furthermore, the intent content is a content of the intent of the additional information, and the information indicating the intent content is, for example, information indicating a mathematical function argument or a function parameter in accordance with the intent type.

In this case, the generative AI generates intent information that includes the information indicating the intent type and the information indicating the intent content. The generation unit 23 is able to acquire information from an external information processing apparatus, an internal storage unit, or the like by using the intent information that is generated by the generative AI, input, to the generative AI, information including the acquired information and instruction information for instructing generation of generation information by using the acquired information, and cause the generative AI to generate the generation information.

Furthermore, the processing unit 12 may include an extraction unit that extracts information on an item included in a prompt by using a certain technology, such as slot filtering. In this case, when the extraction unit extracts pieces of information on a plurality of items from a prompt, the determination unit 22 is able to determine the prompt as a target prompt. In the slot filtering, each of the items is referred to as a slot, but each of the items is not limited to the slot as long as the item indicates a type of a key matter or a characteristic matter as described above.

The extraction unit included in the processing unit 12 extracts the pieces of information on the plurality of items from the prompt based on a rule, for example. For example, the extraction unit may include dictional information that includes a plurality of terms for each of the items, and extract the pieces of information on the plurality of items from the prompt by using the dictionary information.

Moreover, the extraction unit may include an extraction model that extracts the pieces of information on the plurality of items that are included in the prompt, and extract the pieces of information on the plurality of items that are included in the prompt by using the extraction model.

The extraction model is a model that is trained to extract the pieces of information on the plurality of items that are included in the prompt by using learning information that includes a combination of a prompt and pieces of information on a plurality of items that are included in the prompt for each of the prompts. The extraction model is, for example, a model based on Long Short-Term Memory (LSTM) or Transformer, but may be the generative AI as described above or other models.

Furthermore, the extraction unit is able to extract the pieces of information on the plurality of items from the prompt by using a language model, such as text generative AI. For example, the extraction unit is able to input, to the text generative AI, information that includes instruction information for instructing extraction of the pieces of information on the plurality of items from the prompt and the prompt, and cause the text generative AI to extract the pieces of information on the plurality of items.

### 6. Hardware Configuration

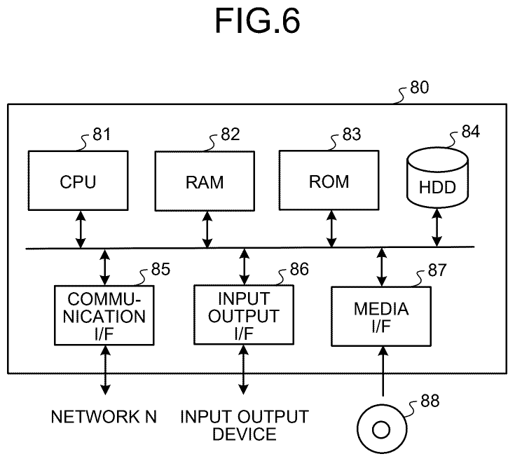

The information processing apparatus 1 according to one embodiment as described above is implemented by, for example, a computer 80 that has a configuration as illustrated in FIG. 6. FIG. 6 is a diagram illustrating an example of a hardware configuration of the computer 80 that implements the functions of the information processing apparatus 1 according to one embodiment. The computer 80 includes a CPU 81, a RAM 82, a Read Only Memory (ROM) 83, a Hard Disk Drive (HDD) 84, a communication interface (I/F) 85, an input output interface (I/F) 86, and a media interface (I/F) 87.

The CPU 81 operates based on a program that is stored in the ROM 83 or the HDD 84, and controls each of the units. The ROM 83 stores therein a boot program that is executed by the CPU 81 at the time of activation of the computer 80, a program that is dependent on hardware of the computer 80, and the like.

The HDD 84 stores therein a program that is executed by the CPU 81, data that is used by the program, and the like. The communication interface 85 receives data from a different apparatus via the network N (see FIG. 2), sends the data to the CPU 81, and transmits data that is generated by the CPU 81 to a different apparatus via the network N.

The CPU 81 controls an output device, such as a display and a printer, and an input device, such as a keyboard or a mouse, via the input output interface 86. The CPU 81 acquires data from the input device via the input output interface 86. Further, the CPU 81 outputs generated data to the output device via the input output interface 86.

The media interface 87 reads a program or data that is stored in a recording medium 88, and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 80 functions as the information processing apparatus 1 according to one embodiment, the CPU 81 of the computer 80 executes a program that is loaded on the RAM 82 and implements the functions of the processing unit 12. Further, the HDD 84 stores therein data in the storage unit 11. The CPU 81 of the computer 80 reads the programs from the recording medium 88 and executes the programs; however, as another example, it may be possible to acquire the programs from a different apparatus via the network N.

### 7. Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the configuration may be flexibly changed such that the information processing apparatus 1 as described above may be implemented by a terminal apparatus and a server computer, may be implemented by a plurality of server computers, or may be implemented by calling an external platform by API or network computing depending on functions.

Furthermore, the embodiments and the modifications as described above may be appropriately combined as long as processing contents do not conflict with each other.

### 8. Effects

As described above, the information processing apparatus 1 according to one embodiment includes the acquisition unit 21 and the estimation unit 25. The acquisition unit 21 acquires evaluation information that is information indicating evaluation on a service using generation information that is information generated by using generative AI based on prompts that include pieces of information on a plurality of items. The estimation unit 25 estimates degrees of importance of the plurality of items based on the evaluation information that is acquired by the acquisition unit 21. With this configuration, the information processing apparatus 1 is able to support optimization of a prompt with increased accuracy.

The estimation unit 25 estimates a degree of importance of each of the items. With this configuration, the information processing apparatus 1 is able to support optimization of a prompt with increased accuracy.

The estimation unit 25 estimates a degree of importance of each combination of the plurality of items. With this configuration, the information processing apparatus 1 is able to support optimization of a prompt with increased accuracy.

Furthermore, the estimation unit 25 estimates degrees of importance of the plurality of items based on evaluation information that is information indicating evaluation on a service using a plurality pieces of generation information each being generated by using generative AI based on a corresponding prompt among a plurality of prompts each including a different combination of pieces of information on a plurality of items.

Moreover, the information processing apparatus 1 includes the selection unit 26 that determines information on one or more items to be included in a new prompt among the pieces of information on the plurality of item based on the degrees of importance of the plurality of items that are estimated by the estimation unit 25. With this configuration, the information processing apparatus 1 is able to support optimization of a prompt with increased accuracy.

Furthermore, the information processing apparatus 1 includes the generation unit 23 that generates a new prompt that includes information on one or more items that are selected by the selection unit 26, and the providing unit 24 that provides the service by using generation information that is information generated by using generative AI based on the new prompt that is generated by the generation unit 23. With this configuration, the information processing apparatus 1 is able to provide information using a prompt that is optimized with increased accuracy.

Moreover, the acquisition unit 21 acquires the evaluation information for each context of the user U who uses the service, the estimation unit 25 estimates the degrees of importance of the plurality of items for each context of the user U, and the selection unit 26 selects information on an item that is to be included in a new prompt from among the pieces of information on the plurality of items for each context of the user U. With this configuration, the information processing apparatus 1 is able to support optimization of a prompt with increased accuracy.

Furthermore, the evaluation on the service is at least one of evaluation that is made by the user U who uses the service and evaluation that is based on a behavior of the user U who uses the service. With this configuration, the information processing apparatus 1 is able to support optimization of a prompt with increased accuracy.

Moreover, the service is an advertisement distribution service, and the generation information is an advertisement content that is distributed by the advertisement distribution service. With this configuration, the information processing apparatus 1 is able to support optimization of a prompt for generating the advertisement content in the advertisement distribution service with increased accuracy.

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

In addition, the “unit (section, module, unit)” described above may be replaced with a “means”, a “circuit”, or the like. For example, the acquisition unit may be replaced with an acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires evaluation information that is information indicating evaluation on a service using generation information that is information that is generated by using generative AI based on a prompt that includes pieces of information on a plurality of items; and
an estimation unit that estimates degrees of importance of the plurality of items based on the evaluation information that is acquired by the acquisition unit.

2. The information processing apparatus according to claim 1, wherein the estimation unit estimates a degree of importance of each of the items.

3. The information processing apparatus according to claim 1, wherein the estimation unit estimates a degree of importance of each combination of the plurality of items.

4. The information processing apparatus according to claim 1, wherein the estimation unit estimates degrees of importance of the plurality of items based on evaluation information that is information indicating evaluation on a service using the plurality pieces of generation information each being generated by using generative AI based on a corresponding prompt among the plurality of prompts each including a different combination of pieces of information on a plurality of items.

5. The information processing apparatus according to claim 1, further comprising:
a selection unit that determines information on one or more items to be included in a new prompt among the pieces of information on the plurality of item based on the degrees of importance of the plurality of items that are estimated by the estimation unit.

6. The information processing apparatus according to claim 5, further comprising:
a generation unit that generates a new prompt that includes information on one or more items that are selected by the selection unit; and
a providing unit that provides the service by using generation information that is information generated by using generative AI based on the new prompt that is generated by the generation unit.

7. The information processing apparatus according to claim 5, wherein
the acquisition unit acquires the evaluation information for each context of a user who uses the service,
the estimation unit estimates the degrees of importance of the plurality of items for each context of the user, and
the selection unit selects information on an item that is to be included in a new prompt from among the pieces of information on the plurality of items for each context of the user.

8. The information processing apparatus according to claim 1, wherein the evaluation on the service is at least one of evaluation that is made by the user who uses the service and evaluation that is based on a behavior of the user who uses the service.

9. The information processing apparatus according to claim 6, wherein
the service is an advertisement distribution service, and
the generation information is an advertisement content that is distributed by the advertisement distribution service.

10. An information processing method implemented by a computer, the information processing method comprising:
acquiring evaluation information that is information indicating evaluation on a service using generation information that is information that is generated by using generative AI based on a prompt that includes pieces of information on a plurality of items; and
estimating degrees of importance of the plurality of items based on the evaluation information that is acquired at the acquiring.

11. A non-transitory computer readable storage medium having stored therein an information processing program that causes a computer to execute a process, the process comprising:
acquiring evaluation information that is information indicating evaluation on a service using generation information that is information that is generated by using generative AI based on a prompt that includes pieces of information on a plurality of items; and
estimating degrees of importance of the plurality of items based on the evaluation information that is acquired at the acquiring.
